(19) United States
(12) Patent Application Publication
(10) Pub. No.: US 2003/0041162 A1
(43) Pub. Date: Feb. 27, 2003

(54) System and method for communicating graphics images over a computer network

(76) Inventors: Roland M. Hochmuth, Ft. Collins, CO (US); John Marks, Ft. Collins, CO (US); Robert P. Martin, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/941,254

(22) Filed: Aug. 27, 2001

(51) Int. Cl. G06F 15/16

(52) U.S. Cl. 709/232; 709/247

(57) ABSTRACT

The present invention is generally directed to a system and method for communicating graphics across one or more computer networks. Broadly, the system comprises an input for receiving a video signal, a memory for storing discrete units of the video signal, and a network interface circuit coupled to both the compression circuit and the computer network, the network interface circuit configured to format and communicate the compressed video signal over the computer network to a remote computer. In a preferred embodiment, the system also includes a compression circuit for compressing a plurality of the discrete units into a compressed video signal. In accordance with another aspect of the invention, a method is provided that receives a video signal, converts the video signal into a format suitable for communication over a computer network, and communicates the converted video signal across the computer network to a remote computer.

### BACKGROUND OF THE INVENTION

1. Field of the Invention

The present invention generally relates to networked computer systems, and more particularly to a system and method for communicating graphics images over a computer network.

2. Discussion of the Related Art

As is known, it is often desired to display computer graphics information, that is generated on one computer, on a remote computer display. Sometimes it is desired to provide this type of remote graphics display across a local area network (LAN), and sometimes it is desired to provide this type of remote display across a wide area network (WAN), such as the Internet.

Various approaches have been undertaken to implement this goal. Generalizing, the approaches of prior art systems involve formatting graphics data into an appropriate network protocol and transmitting the data directly from the source computer. One approach involves reading of the frame-buffer back into a system memory, compressing and assembling IP (Internet Protocol) packets, and then sending the IP packets to the destination computer node. Unfortunately, the process of reading the frame-buffer back into system memory and sending the IP packets to the destination computer node involve significant computation in the color space compution/conversion and compression stage, which significantly impact the input/output (I/O) and memory sub-systems, as well as the central processing unit (CPU) and networking sub-system. As is known, color coalescing is the process of merging multiple display surfaces, such as the primary display surface and overlay planes, as well as the applications of color look-up tables and gamma correction to pixels based on window identifiers (IDs). This process is normally performed by the graphics adapter.

Another approach of prior art systems involves the reception or collection of commands and data being sent to, for example, a graphics card. In certain systems this data is collected, and communicated to a remote client. While this approach may be effective to communicate graphics to a remote client, the remote client generally 10 must have all the capabilities to render graphics as the computer sending the three-dimensional (3-D) commands and models. While this approach may be effective for small models of small complexity, 3-D models are unbounded in terms of their complexity and many models may be hundreds of megabytes in size.

Another disadvantage of prior art systems is that they generally require operating system-dependent (OS-dependent) code that operates at the device driver layer, which must be written to control the devices. This OS-dependent code varies from system to system. In addition, the remote client must have all the capabilities of the source computer, such as memory to hold 3-D models and a 3-D graphics adapter to accelerate the rendering of the model.

### SUMMARY OF THE INVENTION

To achieve certain advantages and novel features, the present invention is generally directed to a system and method for communicating graphics across one or more computer networks. Broadly, the system comprises an input for receiving a video signal, a memory for storing discrete units of the video signal, and a network interface circuit coupled to both the compression circuit and the computer network, the network interface circuit configured to format and communicate the compressed video signal over the computer network to a remote computer. In a preferred embodiment, the system also includes a compression circuit for compressing a plurality of the discrete units into a compressed video signal.

In accordance with another aspect of the invention, a method is provided that receives a video signal, converts the video signal into a format suitable for communication over a computer network, and communicates the converted video signal across the computer network to a remote computer.

### DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram illustrating a system constructed in accordance with one embodiment of the invention;

FIG. 2 is a block diagram of a network video apparatus (NVA) constructed in accordance with one embodiment of the invention;

FIG. 3 is a flowchart illustrating the top-level operation of an apparatus constructed in accordance with one embodiment of the invention;

FIG. 4 is a block diagram similar to FIG. 1, but illustrating a system constructed in accordance with another embodiment of the invention;

FIG. 5 is a block diagram, similar to the diagram of FIG. 2, but illustrating components of a NVA constructed in accordance with the embodiment illustrated in FIG. 4;

FIG. 6 is a block diagram similar to FIG. 1, but illustrating a system constructed in accordance with another embodiment of the invention;

### DETAILED DESCRIPTION OF THE PREFERRED EMBODIMENT

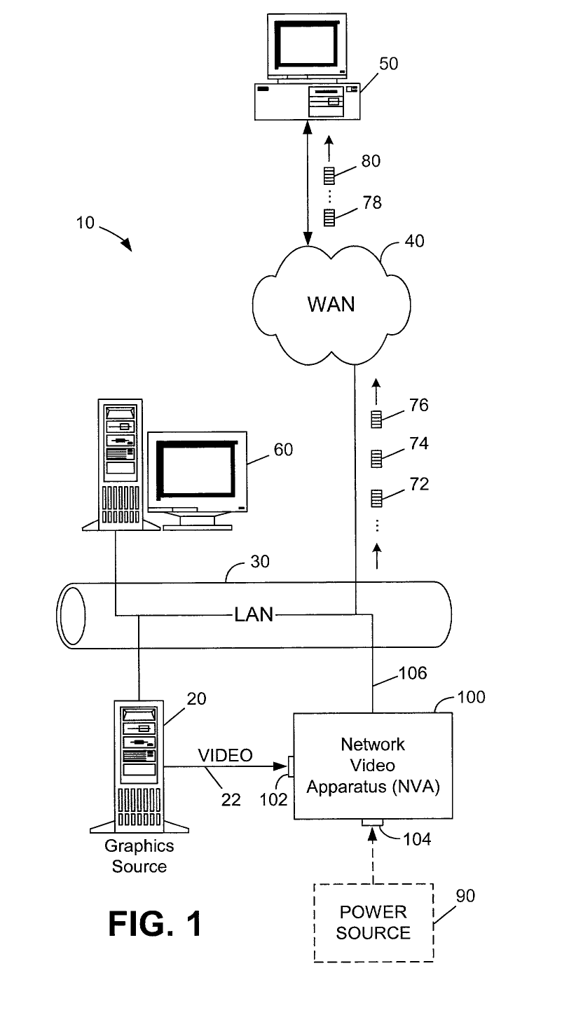

Turning now to the drawings, reference is now made to FIG. 1, which is a diagram illustrating certain principal components of a system 10 constructed in accordance with one embodiment of the present invention. More particularly, the system 10 comprises components that cooperate to communicate video information from a source computer 20 to a destination computer 50 across one or more networks. In the illustrated embodiment, the system 10 comprises both a local area network (LAN) 30 as well as a wide area network (WAN) 40. In many configurations, the WAN 40 will be the Internet.

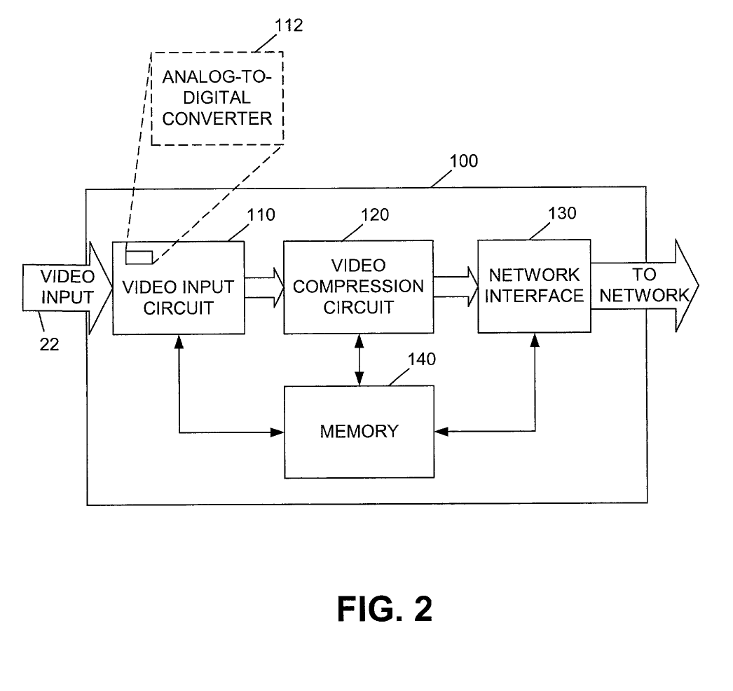

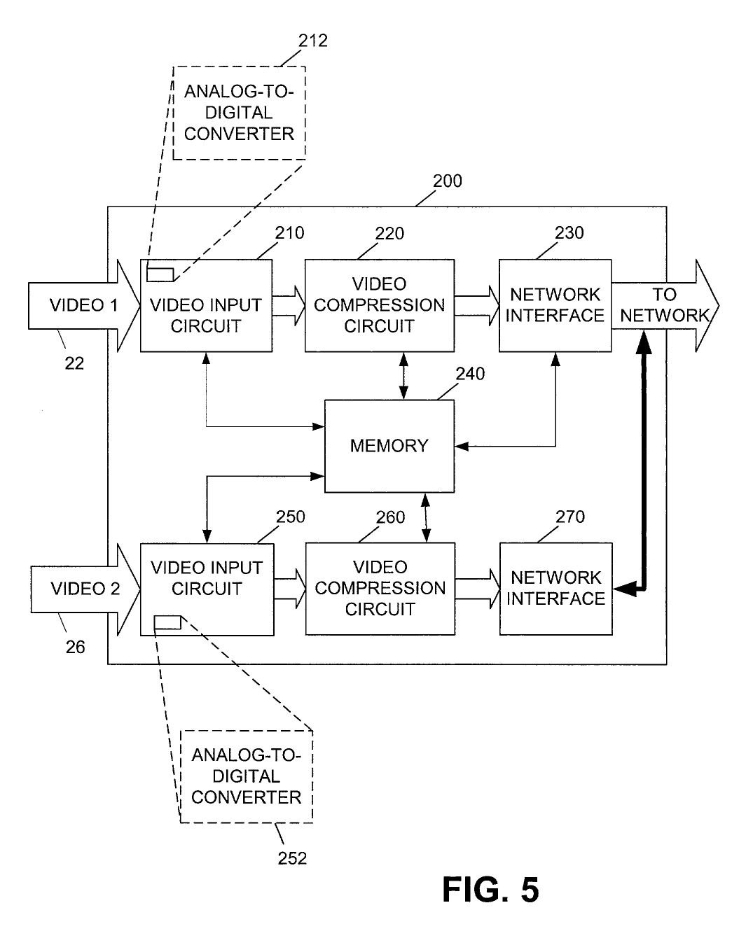

To facilitate the communication of video information from a source computer to a destination computer 50, a novel network video apparatus (NVA) 100 is provided. Various embodiments of such a NVA 100 will be described in more detail herein (e.g., FIGS. 2 and 5). In short, the NVA 100 operates by receiving a video signal at an input, formatting the video signal for network communication, and outputting the formatted video signal across one or more networks. More particularly, a standard or conventional video signal, such as a video signal generated by a video graphics card, may be connected to the NVA 100. This connection may be made through conventional cabling 22 and a connector 102 coupled to an input of the NVA 100.

The NVA 100 may store the video signal in an internal memory. The video signal may be either a digital video signal, such as a Digital Visual Interface (DVI) compliant signal, or may be an analog video signal. If the video signal carried on cable 22 is an analog signal, then the NVA 100 will perform an appropriate analog-to-digital conversion, before storing the video signal in memory. Preferably, a compression is performed of the video information stored in memory, before communicating the video information over the networks. Such a compression can significantly reduce the amount of data that is transmitted across the networks 30 and 40. Alternatively, the compression and conversion to IP may occur without the need for an intermediate memory and storage and could occur on-the-fly. In other words, the intermediate memory for storing the display buffer and compressed display buffer may, in some embodiments, be eliminated. Thus, with regard to this compression, it will be appreciated that a variety of compression algorithms may be utilized in accordance with the scope and spirit of the present invention.

In addition to compressing the video information, the NVA 100 also formats the video information for communication across the networks 30 and 40. In the preferred embodiment, the video information is formatted into a plurality of Internet protocol (IP) packets 72, 74, 76, 78, and 80 that are communicated across the networks 30 and 40. The formatted data packets will comprise, among other things, an identification of the destination computer 50 to which the video information is to be transmitted. If the video information is transmitted in accordance with the Internet protocol, this destination identification may simply be an IP address. Since the Internet protocol is well-known, no discussion deed be provided herein with regard to this protocol or the manner in which the video information is formatted in compliance with such a protocol. Furthermore, alternative protocols may be utilized in accordance with the present invention.

Of course, as will be appreciated by persons skilled in the art, the source computer 20 will communicate to the NVA 100 the address (or other identifier) of the destination computer 50. Preferably, this communication occurs across the network 30. In this regard, when the NVA 100 is connected to the LAN 30, the LAN server 60 and other devices on the LAN become aware of its existence on the network (through network communications and methodologies that are well-known, and need not be described herein). The source computer 20, then may send a short network communication to the NVA to inform it of the destination computer 50.

Alternatively, the source computer 20 may have a direct connection to the NVA 100, over which the destination information is communicated. For example, a cable may be connected between a serial port, a parallel port, a USB port, etc. of the source computer to an appropriate connector or port of the NVA 100. Similarly, a wireless interface may also be implemented in accordance with the scope and spirit of the invention.

Regardless of whether the destination address is communicated over the LAN 30 or through a direct connection between the source computer 20 and the NVA 100, it should be appreciated that only a minimal set of software drivers will be required to be installed on the source computer 20. It should be further appreciated that the addition and installation of the NVA to the LAN 30 will be a rather simple task.

It is presumed, for purposes of this discussion, that the destination computer 50 will comprise an appropriate network interface for receiving the data packets 72, 74, 76, 78, and 80 that carry the video information. It is also presumed that the destination computer 50 comprises appropriate software for evaluating the received packets and placing the collective video data into a frame buffer or other appropriate video memory for re-creating the video signal at the destination computer 50. Of course, this reconstructed video signal will drive an appropriate monitor or display (or display window). The implementation of this functionality at a destination computer is considered to be within the level of one possessing ordinary skill in the art, based upon the teachings herein, and therefore need not be described further herein.

Also illustrated in FIG. 1 is a computer 60. This computer 60 may be configured as a server that controls or governs communications across the LAN 30, as well as communications between the LAN 30 and WAN 40. Such computers and their operation are well-known, and therefore need not be described herein.

Also illustrated in FIG. 1 is a power source 90. In one embodiment of the present invention, the NVA 100 is provided as a stand-alone appliance (as illustrated in FIG. 1). Of course, if the NVA 100 is provided as a stand-alone appliance, then it will need to be provided power for operation. In one embodiment, this power may be provided through an internal battery. In another embodiment, this power may be provided by a standard wall outlet and a power cord connected through an appropriate connector 104 provided on the NVA 100. These features, however, are not deemed to be limitations upon the broader scope and spirit of the present invention.

Such an implementation (i.e., stand-alone) of the NVA allows for extremely convenient installation and setup. In this regard, a system in accordance with the invention may be set up essentially by connecting a cable between the source computer 20 and the NVA 100, and connecting the NVA 100 (via a cable 106) to the network 30. A minimal set of appropriate software drivers may also need to be installed on the computer 20, as well as the destination computer 50.

Reference is now made to FIG. 2, which is a block diagram illustrating certain components of the NVA 100 constructed in accordance with one embodiment of the present invention. As mentioned in connection with FIG. 1, the NVA 100 may be connected to the video source through a cable 22, and likewise may be connected to a LAN 30 through cabling 106. Internally, the NVA 100 may comprise a video input circuit 110. This circuit may vary from embodiment to embodiment, but will generally comprise the necessary circuit components for receiving a video signal and formatting the signal for interface with other components within the NVA 100. By way of example, if the video signal carried on cable 22 is an analog signal, then the video input circuit 110 may comprise an analog-to-digital converter 112. The video input circuit 110 may also comprise the necessary circuit components for storing discrete units of the composite video signal into a memory 140. The particular implementation of the video input circuit is not deemed to be a limitation on the scope and spirit of the present invention, and therefore is not described herein, as circuit designers or persons skilled in the art will appreciate how to design and/or implement a video input circuit consistent with the teachings herein.

In a preferred embodiment, the NVA 100 also comprises a video compression circuit 120. Functionally, the video compression circuit 120 may operate to read video data stored in the memory 140 and compress that data for more efficient communication over the networks 30 and 40. In the preferred embodiment, such a compression circuit 120 may be implemented using general-purpose hardware components, such as a digital signal processor or microprocessor, and appropriate software for controlling the operation of the hardware components. Of course, consistent with the invention, the video compression circuit 120 may be implemented using dedicated hardware or an application-specific integrated circuit (ASIC) that is specially designed for carrying out the compression function. As previously mentioned, any of a variety of compression algorithms may be utilized in connection with the invention. Indeed, certain embodiments of the present invention may not compress the video data at all, thereby eliminating the video compression circuit 120 from the NVA 100.

Finally, the NVA 100 comprises a network interface circuit 130. The network interface circuit 130 is designed to format the video data for communication over the networks 30 and 40. In this regard, the network interface circuit 130 may be configured to packetize the video data (e.g., in accordance with the Internet protocol). The network interface circuit 130 may also be configured to interface with the video compression circuit 120 and/or the memory 140. In this regard, the network interface circuit 130 may be configured to operate “on the fly,” receiving data output from the video compression circuit 120, perform the appropriate formatting of the data, and direct it to the network. Alternatively, the video compression circuit 120 may operate to compress the video data and write the compressed video data back into the memory 140. In such an embodiment, the network interface circuit 130 may be configured to read the video data from the memory 140, then format that data and direct it to the network.

Again, as mentioned above, one embodiment of the NVA 100 may be configured to transmit video data in an uncompressed format. In such embodiment, the video information may be directed from the video input circuit 110 directly to the network interface 130 for formatting and transmission. Alternatively, the video information may be directed from the video input circuit 110 to the memory 140. The network interface circuit 130 may then read data directly from the memory 140, and then format the video data for transmission. Of course, other implementations and embodiments of the NVA 100 may be readily appreciated from the discussion herein, and may be so constructed in accordance with the spirit of the present invention.

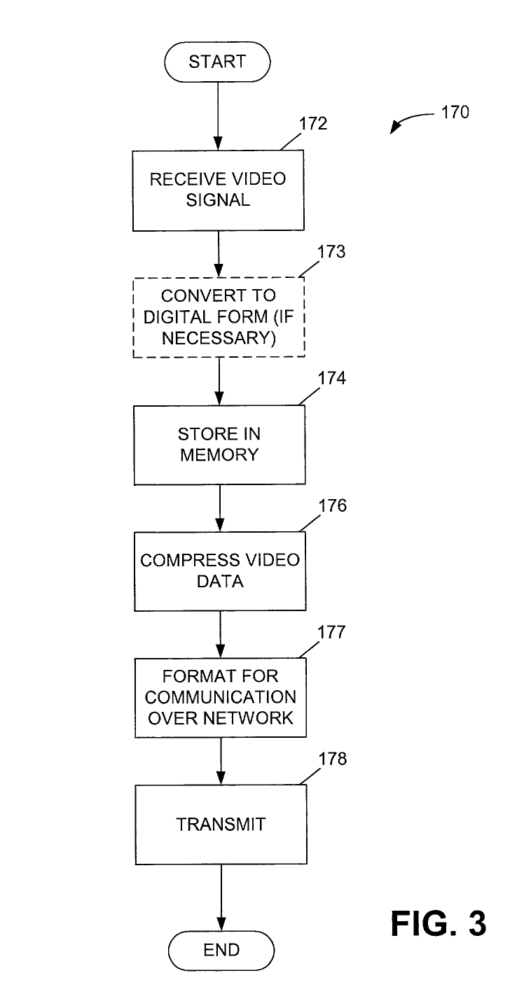

Having described the principal operation and structure of one embodiment of the present invention, it should be appreciated that the present invention also embodies various methods for communicating video signals from the source computer 20, across one or more networks 30 and 40 to a remote, destination computer 50. In this regard, reference is made to FIG. 3, which is a flowchart illustrating one embodiment 170 of such a method. In accordance with this illustrated embodiment, a video signal (originated by a source computer) is received at a video input (step 172). Thereafter, if the video signal is an analog signal, then it is converted into digital form (step 173). Since the step is optional, depending upon the format of the video signal, it has been illustrated in FIG. 3 in dashed outline. Thereafter, the received video signal may be stored in memory (step 174). In this regard, numerous discrete data units comprising the video signal (e.g., one frame of video) are stored in memory. In the preferred embodiment, the stored video data is compressed using any of a variety of compression algorithms (step 176). Thereafter, the compressed video data is formatted for communication over one or more networks (step 177). Finally, the compressed video data is transmitted over the one or more networks to a remote, destination computer (step 178).

It should be appreciated that a flowchart of FIG. 3 is presented purely for purposes of illustrating one embodiment of the present invention. As described herein, various alternative embodiments may be implemented as well. For example, in one embodiment the video data may not be stored in memory, but rather may be received, formatted for network communication, and communicated over the one or more networks “on the fly.” Such a real-time implementation may be realized whether the video data is compressed or uncompressed. Of course, the destination computer must be equipped with appropriate software for reconstructing the original video signal. Thus, if the source video signal is compressed prior to transmission over the network, then the appropriate decompression software and/or hardware must be resident on the destination computer. Implementation details such as these will be readily apparent and understood by persons skilled in the art, and therefore need not be described further herein.

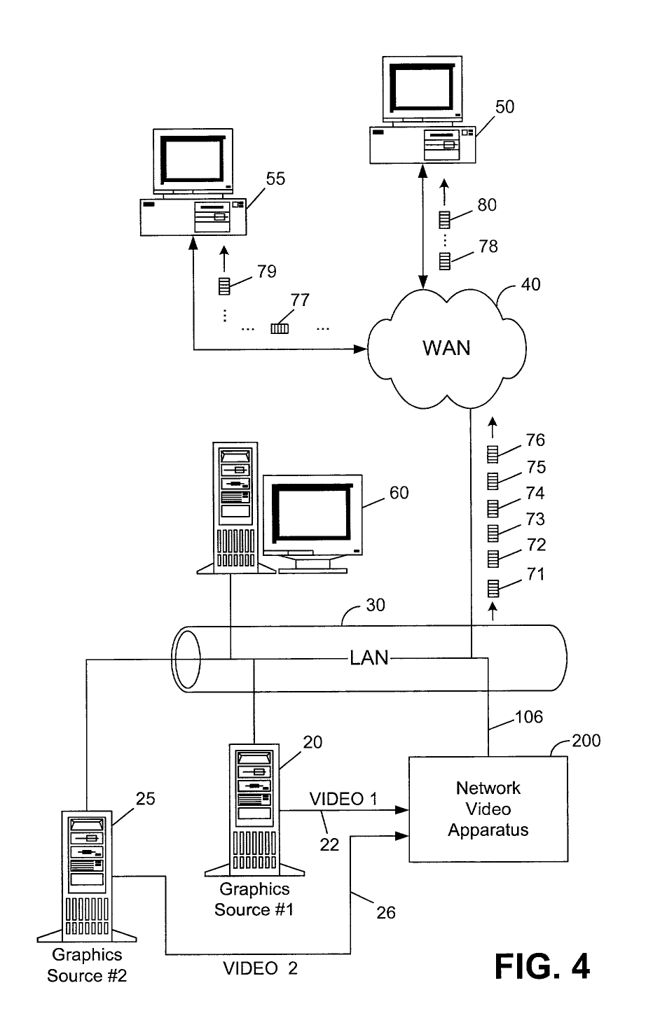

Having described the principal structure and operation of one embodiment of the present invention, reference is now made to FIG. 4, which illustrates an alternative embodiment of the present invention. In short, the embodiment of FIG. 4 is similar to the embodiment illustrated in FIG. 1, except that an additional source computer 25 and an additional destination computer 55 are shown. Where appropriate, the reference numerals used in FIG. 1 have been preserved. Like the source computer 20, the second source computer 25 may be connected to the NVA 200 through conventional video cabling 26. Of course, the NVA 200 of this embodiment may comprise an additional connector or port (not shown) for receiving the additional video cable 26. Consistent with the concepts and teachings of the present invention, additional connectors or ports may be provided on the NVA 200 so that additional (not shown) graphics sources may be accommodated.

Likewise, an additional destination computer 55 may be provided. In this regard, the video information from the first source computer 20 may be destined for a first remote computer 50. As described in connection with FIG. 1, the NVA 200 may operate to convert the video signal carried on cable 22 into appropriate IP packets 72, 74, 76, 78, and 80 that may be communicated over the networks 30 and 40 to the remote computer 50. In similar fashion, the NVA 200 may operate to convert the video signal carried on cable 26 into appropriate IP packets 71, 73, 75, 77, and 79 that may be communicated over networks 30 and 40 to the remote computer 55. Upon receiving these packets, remote computer 55 may be configured to reconstruct the original video image embodied in the video signal carried on cable 26. This video image reconstruction may operate as previously described in connection with the destination computer 50.

Reference is now made briefly to FIG. 5, which is a block diagram similar to the diagram of FIG. 2, which illustrates certain principal components that may be provided within the NVA 200. As described in connection with FIG. 2, a video input circuit 210 is provided to receive the video signal carried on cable 22. If appropriate, the video input circuit 210 may comprise an analog-to-digital converter 212, which may operate to convert an analog video signal into digital values. The video compression circuit 220, network interface 230, and memory 240 may also be provided and configured to operate like the corresponding components described in FIG. 2.

In addition, a second video input circuit 250 may be provided and configured to receive the video signal carried on cable 26. Like the video input circuit 210, the video input circuit 250 may comprise an analog-to-digital converter 252. Also, a second video compression circuit 260 and a second network interface 270 may also be provided within NVA 200. Alternatively, the NVA may be designed such that the same circuitry could be utilized for compressing and sending data received from a second (or additional) input ports. The function or operation of these components will be similar to the video input circuit 110, video compression circuit 120, and network interface circuit 130, that were described in connection with FIG. 2. It will be appreciated that, although these components have been illustrated separately for purposes of simplifying the discussion herein, the actual implementation may be designed so that certain components are shared. For example, the NVA 200 may be designed with a single network interface circuit that is designed and configured with the remainder of the circuitry to handle network communications for both video streams.

Although not explicitly shown in FIG. 5, it should be appreciated that additional components may be comprised within the NVA 200 to accommodate additional video streams.

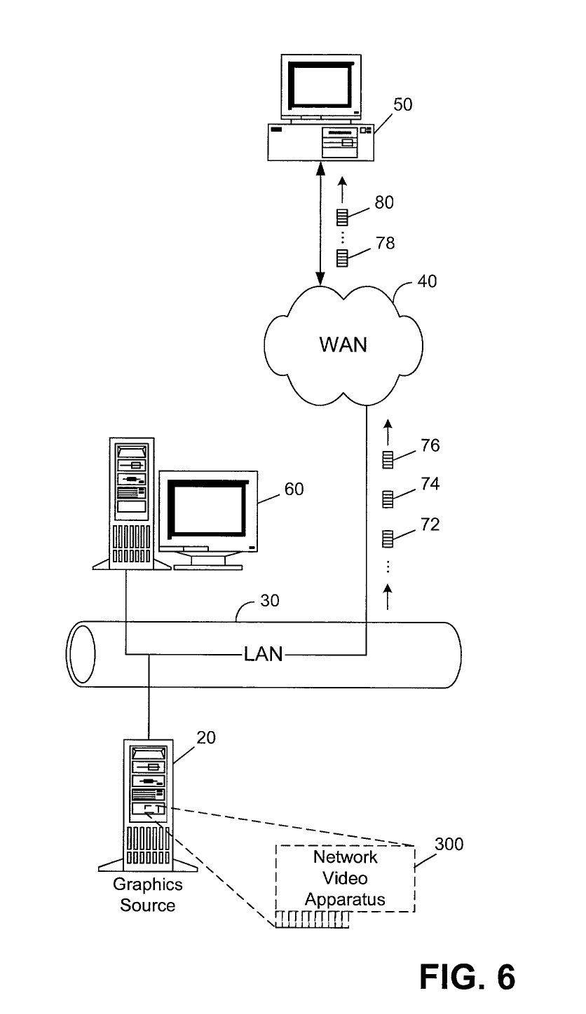

Reference is now made to FIG. 6, which is a diagram similar to the diagram of FIG. 1, but illustrating yet another embodiment of the present invention. Where appropriate, the reference numerals used in FIG. 1 have been preserved. As illustrated in FIG. 6, rather than providing the NVA 100 or 200 as a separate or stand-alone device, it may be integrated within the computer 20 containing the graphics source. In this regard, the NVA 300 may be provided on a circuit card that may be plugged directly into, for example, a motherboard of the computer 20. In such an embodiment, the NVA 300 may utilize a network interface provided as a part of computer 20 (or a network card that may be plugged into the computer—e.g., an Ethernet card). In this way, separate network connections between the NVA 300 in the network 30 may not be required. In addition, the NVA 300 could receive its power supply signals directly from the power supply of the computer 20. However, it will be appreciated that an embodiment such as that illustrated in FIG. 6 may require additional software drivers to be installed on the computer 20 to appropriately recognize and/or configure the circuit card 300. Aside from these differences, the structure and operation of the circuitry provided on the NVA 300 may be substantially the same as that described in connection with NVA 100 and 200.

From the foregoing discussion, it should be appreciated that certain embodiments of the present invention provide a NVA 100, 200, or 300 that is attached to the video output of a graphics adapter on a source computer node. FIGS. 1, 4, and 6 show diagrams of how the invention could be used in a network topology. The NVA may compress and convert the video output into a sequence of IP (Internet Protocol) packets or some other network protocol.

The video output may be a digital signal as in DVI, or it may be an analog video signal. The IP packets may be sent to a destination computer node on the network. The destination computer node 50 may receive the IP packets from the NVA 100, 200, or 300, decompress them, assemble the image, and then display the results in a window on a display device of the computer 50. The decompression, assembly, and display of the image can be implemented in a software client written as a JAVA program, JAVA applet, native implementation, or some other method running on the destination computer node 50, consistent with the invention. The software client may optionally control the NVA 100, 200, or 300 by configuring the refresh rate, window size on the destination computer node 50, or other parameters. Additional hardware to assist in this process may also be used on the destination computer node 50. Such additional hardware will be understood by persons skilled in the art from the teachings provided herein, and need not be described further.

Another way to think about this is, instead of a monitor being attached to the video output of a graphics adapter card of the source computer node 20, an RGB-to-IP (red-green-blue-to-IP) converter may be attached (of course, both may be attached to receive the same video signal). This converter (e.g., the NVA 100, 200, or 300) can compress and transmit the output to one or more destination IP addresses. In one embodiment, the NVA may be configured to transmit the same video information to a plurality of destination computers.

The NVA 100, 200, or 300 may comprise one or more video input ports, either analog or digital, one or more DSPs or similar low-cost, high-performance embedded controller, CPU or custom chip, one or more Ethernet ports or similar network interface ports, RAM, and other miscellaneous parts. The video input port is connected to a video output of the graphics port on the source computer node 20. The CPU or DSP preferably compresses the video signal and encapsulates the data in IP or other network protocol. The packets are then sent out the network interface port. The appliance may comprise other ports such as RS-232 or power. As should be appreciated by persons skilled in the art, the CPU or DSP could also be a field programmable gate array (FPGA), an application specific integrated circuit (ASIC), an embedded CPU, or some combination or variant of such devices.

It will be appreciated from the foregoing that numerous advantages are realized by the invention that has been described herein through several embodiments. One such advantage is platform independence. No low-level OS or device driver changes are required on the source computer node 20. Indeed, the system described herein is OS-independent and hardware-independent.

Another advantage is that no additional computational overhead on the source computer node 20 is required. As is known, certain traditional techniques involve significant computation in the color space coalescing conversion (e.g., the application of color look-up tables to window IDs) and compression stage. These significant computations are avoided in the system of the invention.

The embodiments described herein should not be construed as limiting on the present invention, but rather should be construed as illustrative. Indeed, numerous variations of the embodiments specifically described herein may be implemented, consistent with the scope and spirit of the invention. For example, the functionality embodied in the NVA described herein may be integrated onto a graphics adapter either using a separate chip or within the graphics chip itself. One place where this may be implemented is the point that the RAMDAC (random access memory digital-to-analog converter) is traditionally located in a graphics chip.

Alternatively, the functionality embodied in the NVA may be integrated onto a PCI-based (peripheral component interface-based) board that plugs into the source computer node. This would simplify the power requirements for the apparatus. The PCI board could accept video input from the video output of the graphics device. A DSP (digital signal processor), FPGA (floating-point gate array), or ASIC (application-specific integrated circuit) on the PCI board would compress and convert the data to some IP based protocol. The IP would be sent on a network interface port.

In yet another embodiment, the functionality embodied in the NVA may be embodied into a block of code, such as Verilog, and sold to a graphics chip design company to be implemented in the graphics adaptors.

What is claimed is:

1. An apparatus for communicating graphics between at least two remotely-located computers across a computer network comprising:
an input for receiving a video signal output from a graphics card of a source computer;
a memory for storing discrete units of the video signal;
a compression circuit for compressing a plurality of the discrete units into a compressed video signal;
a network interface circuit coupled to both the compression circuit and the computer network, the network interface circuit configured to format and communicate the compressed video signal over the computer network to a remote computer; and
an output coupled to the computer network.

2. An apparatus for communicating graphics across a computer network comprising:
an input for receiving a video signal;
a memory for storing discrete units of the video signal;
a compression circuit for compressing a plurality of the discrete units into a compressed video signal; and
a network interface circuit coupled to both the compression circuit and the computer network, the network interface circuit configured to format and communicate the compressed video signal over the computer network to a remote computer.

3. The apparatus of claim 2, wherein the video signal is in compliance with a Digital Visual Interface (DVI) standard.

4. The apparatus of claim 2, wherein the video signal is an analog video signal.

5. The apparatus of claim 2, further comprising a circuit for converting an analog video signal into a digital video signal.

6. The apparatus of claim 2, wherein the computer network comprises a local area network (LAN).

7. The apparatus of claim 2, wherein the computer network comprises a wide area network (WAN).

8. The apparatus of claim 2, wherein the network interface circuit is configured to format the compressed video signal into a plurality of Internet Protocol (IP) packets that are communicated over the computer network to the remote computer.

9. The apparatus of claim 2, further comprising a second input for receiving a second video signal.

10. The apparatus of claim 9, wherein the compression circuit is further configured to separately compress a plurality of discrete units for each of the video signals.

11. The apparatus of claim 2, wherein the network interface circuit is configured to format and communicate separately compressed video signals to different remote computers, such that a first remote computer receives a first compressed video signal and a second remote computer receives a second compressed video signal.

12. The apparatus of claim 2, further comprising a plurality of network interface circuits, each network interface circuit being coupled to both a compression circuit and the computer network, each network interface circuit being configured to format and communicate the compressed video signal over the computer network to a remote computer.

13. The apparatus of claim 2, wherein the apparatus comprises a connector for direct connection to a source computer that supplies the video signal, wherein the connector comprises signals carrying power signals for powering the apparatus.

14. The apparatus of claim 13, wherein the connector is an edge connector configured to directly plug into a card slot of a motherboard of the source computer.

15. An apparatus for communicating graphics across a computer network comprising:
an input for receiving a video signal; and
a network interface circuit coupled to both the input and the computer network, the network interface circuit configured to format and communicate the video signal over the computer network to a remote computer.

16. The apparatus of claim 15, wherein the network interface circuit is configured to format the video signal into a plurality of Internet Protocol (IP) packets that are communicated over the computer network to the remote computer.

17. The apparatus of claim 15, further comprising a second input for receiving a second video signal.

18. The apparatus of claim 15, wherein the network interface circuit is configured to separately format and communicate each received video signal to different remote computers, such that a first remote computer receives the a first video signal and a second remote computer receives a second video signal.

19. A method for communicating graphics across a computer network comprising:
receiving a video signal;
converting the video signal into a format suitable for communication over a computer network; and
communicating the converted video signal across the computer network to a remote computer.

20. The method of claim 19, wherein the step of converting comprises forming a plurality of Internet Protocol (IP) packets collectively embodying the video signal.
